(19) United States
(12) Patent Application Publication
(10) Pub. No.: US 2026/0218757 A1
(43) Pub. Date: Jul. 30, 2026

(54) POWER TRANSMISSION DEVICE

(71) Applicant: EXEDY Corporation, Osaka (JP)

(72) Inventor: Hiroshi UEHARA, Osaka (JP)

(21) Appl. No.: 19/451,595

(22) Filed: Jan. 16, 2026

(30) Foreign Application Priority Data
Jan. 24, 2025 (JP) 2025-010705
Mar. 18, 2025 (JP) 2025-043659

(51) Int. Cl. F16D 3/12; F16D 3/66; F16D 7/02

(52) U.S. Cl. CPC F16D 3/12; F16D 7/025; F16D 3/66

(57) ABSTRACT

A power transmission device having a first inertia block includes a first threaded hole and a second threaded hole. A second inertia block includes a third threaded hole. The second inertia block is disposed away from the first inertia block at an interval in a circumferential direction. The first and second inertia blocks are disposed between a drive plate and a torque fluctuation inhibiting device in an axial direction. A first bolt is screwed in the first threaded hole. The first bolt fastens the drive plate and the first inertia block therethrough to each other. The second bolt is screwed into the second threaded hole. The second bolt fastens the torque fluctuation inhibiting device and the first inertia block therethrough to each other. A third bolt is screwed into the third threaded hole. The third bolt fastens the drive plate and the second inertia block therethrough to each other.

### CROSS-REFERENCE TO RELATED APPLICATIONS

This application is based on and claims the priority benefit of Japanese applications Nos. 2025-010705 filed on Jan. 24, 2025, and 2025-043659 filed on Mar. 18, 2025, the contents of which are incorporated herein by reference.

### TECHNICAL FIELD

The present invention relates to a power transmission device.

### BACKGROUND

A power transmission device disclosed in Japan Laid-open Patent Application Publication No. 2024-030506 includes a flywheel, a torque limiter, and a damper unit. The flywheel includes a flexible plate and an inertia ring. The torque limiter is attached to the inertia ring. The inertia ring is provided with threaded holes; then, the flexible plate and the torque limiter are fixed to the inertia ring by screwing bolts into the threaded holes.

### SUMMARY OF THE INVENTION

It is an object of the present invention to provide a power transmission device in which it is made possible to lay out threaded holes in desired positions when a plurality of inertia blocks, employed instead of an inertia ring, are disposed at intervals in a circumferential direction.

A power transmission device according to a first aspect includes a drive plate, a torque fluctuation inhibiting device, a first inertia block, a second inertia block, a first bolt, a second bolt, and a third bolt. The torque fluctuation inhibiting device is configured to inhibit fluctuations in torque. The first inertia block includes a first threaded hole and a second threaded hole. The first inertia block is disposed between the drive plate and the torque fluctuation inhibiting device in an axial direction. The second inertia block includes a third threaded hole. The second inertia block is disposed between the drive plate and the torque fluctuation inhibiting device in the axial direction. The second inertia block is disposed away from the first inertia block at an interval in a circumferential direction. The first bolt is screwed into the first threaded hole of the first inertia block. The first bolt fastens the drive plate and the inertia block therethrough to each other. The second bolt is screwed into the second threaded hole of the first inertia block. The second bolt fastens the torque fluctuation inhibiting device and the first inertia block therethrough to each other. The third bolt is screwed into the third threaded hole of the second inertia block. The third bolt fastens the drive plate and the second inertia block therethrough to each other.

In a well-known type of power transmission device, the inertia ring is provided with a plurality of threaded holes away from each other at intervals in the circumferential direction. Besides, the drive plate and the torque fluctuation inhibiting device are disposed to interpose the inertia ring therebetween; then, the drive plate and the torque fluctuation inhibiting device are fixed to the inertia ring by a plurality of bolts. When it is herein assumed to employ, instead of the inertia ring, a plurality of inertia blocks disposed at intervals in the circumferential direction, it is inevitable to impose limitations on intervals between threaded holes for fixing the drive plate to the inertia blocks and those for fixing the torque fluctuation inhibiting device to the inertia blocks. Specifically, the inertia blocks are disposed away from each other at predetermined intervals in consideration of rotational balance; hence, the threaded holes provided in the inertia blocks are disposed away from each other at the predetermined intervals as well.

By contrast, in the power transmission device according to the first aspect, the first inertia block is provided with the first and second threaded holes; hence, it is made possible to set the interval between the first and second threaded holes without depending on the interval between the inertia blocks. As a result, it is made possible to lay out the threaded holes in desired positions.

A power transmission device according to a second aspect relates to the power transmission device according to the first aspect and is configured as follows. The first inertia block is identical in shape to the second inertia block except for difference in number between the first and second threaded holes and the third threaded hole.

A power transmission device according to a third aspect relates to the power transmission device according to the first or second aspect and is configured as follows. The drive plate includes a first cylindrical portion extending in the axial direction. The first and second inertia blocks are disposed radially inside the first cylindrical portion.

A power transmission device according to a fourth aspect relates to the power transmission device according to the third aspect and is configured as follows. The drive plate includes a flexible plate and an inertia plate. The inertia plate is configured to be rotated unitarily with the flexible plate. The inertia plate has an annular shape. The flexible plate has a larger plate thickness than the flexible plate. The inertia plate includes the first cylindrical portion.

A power transmission device according to a fifth aspect relates to the power transmission device according to the third or fourth aspect and is configured as follows. The torque fluctuation inhibiting device includes a second cylindrical portion extending in the axial direction. The second cylindrical portion is disposed radially outside the first cylindrical portion.

A power transmission device according to a sixth aspect relates to the power transmission device according to any of the first to fifth aspects and is configured as follows. The torque fluctuation inhibiting device includes a torque limiter attached to the drive plate. The torque limiter includes a first side plate, a friction plate, a pressure plate, and an urging member. The friction plate is disposed to be rotatable relative to the first side plate. The pressure plate holds the friction plate in cooperation with the first side plate, with the friction plate interposed therebetween. The urging member urges the pressure plate toward the first side plate in the axial direction. The second bolt fastens the first side plate and the first inertia block therethrough to each other.

Overall, according to the present invention, it is made possible to lay out threaded holes in desired positions.

### BRIEF DESCRIPTION OF THE DRAWINGS

FIG. 1 is a front view of a power transmission device.

FIG. 2 is a cross-sectional view of the power transmission device taken along line II-II in FIG. 1.

FIG. 3 is a front view of the power transmission device (bolts are not shown) from which a torque fluctuation inhibiting device is detached.

FIG. 4 is a cross-sectional view of the power transmission device taken along line IV-IV in FIG. 1.

FIG. 5 is a cross-sectional view of the power transmission device taken along line V-V in FIG. 1.

FIG. 6 is an enlarged cross-sectional view of the power transmission device.

FIG. 7 is a diagram of a power transmission device (bolts are not shown) according to a modification and corresponds to FIG. 3.

### DETAILED DESCRIPTION

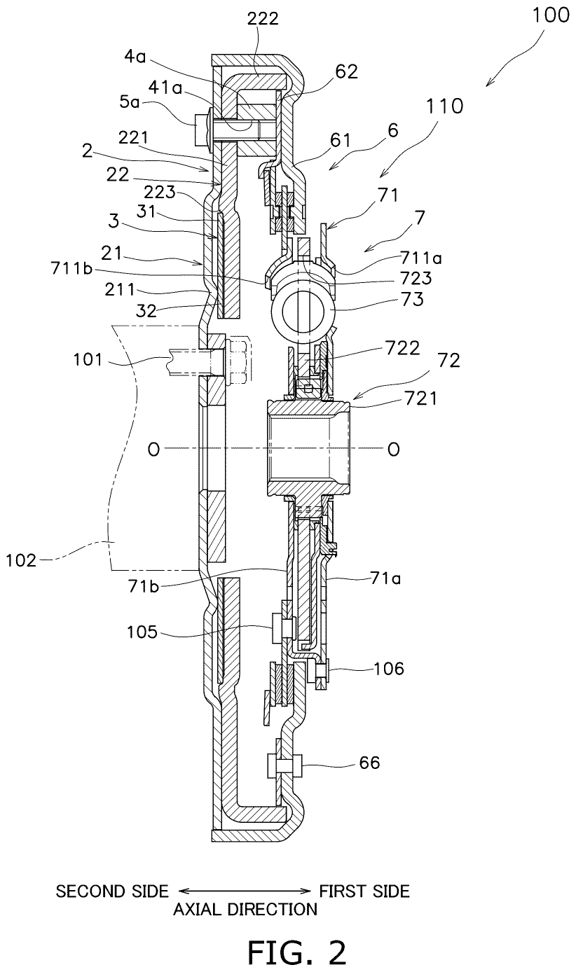

A power transmission device 100 according to the present preferred embodiment will be hereinafter explained with reference to drawings. It should be noted that in the following explanation, the term “axial direction” refers to an extending direction of a rotational axis O for the power transmission device 100. On the other hand, the term “circumferential direction” refers to a circumferential direction of an imaginary circle about the rotational axis O, whereas the term “radial direction” refers to a radial direction of the imaginary circle about the rotational axis O. Besides, the term “first side in the axial direction” means the right side in FIG. 2, whereas the term “second side in the axial direction” means the left side in FIG. 2.

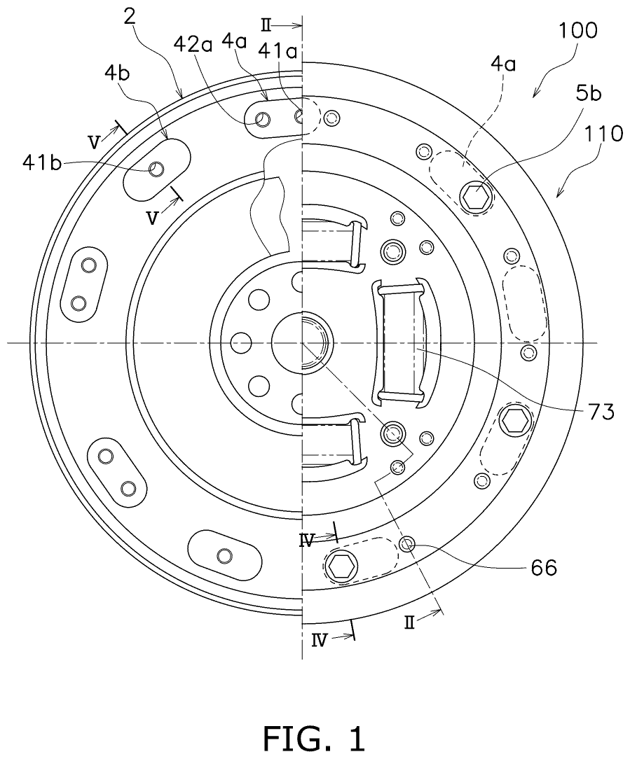

FIG. 1 is a front view of the power transmission device 100, whereas FIG. 2 is a cross-sectional view of the power transmission device 100 taken along line II-II in FIG. 1. As shown in FIGS. 1 and 2, the power transmission device 100 includes a drive plate 2, a disc spring 3, a plurality of first inertia blocks 4a, a plurality of second inertia blocks 4b, a plurality of first bolts 5a, a plurality of second bolts 5b, a plurality of third bolts 5c (see FIG. 5), and a torque fluctuation inhibiting device 110. The torque fluctuation inhibiting device 110 includes a torque limiter 6 and a damper unit 7.

The drive plate 2, the disc spring 3, the first and second inertia blocks 4a and 4b, the first to third bolts 5a to 5c, and the torque limiter 6 are configured to be rotated unitarily with each other. The torque limiter 6 and the damper unit 7, albeit rotatable relative to each other, are basically rotated unitarily with each other. When a torque inputted to the power transmission device 100 exceeds a predetermined value, the torque limiter 6 and the damper unit 7 are rotated relative to each other.

The power transmission device 100 is installed between a prime mover (omitted in illustration) and an output-side member (omitted in illustration). It should be noted that the prime mover refers to, for instance, an internal combustion engine. On the other hand, the output-side member refers to, for instance, an electric motor, a power generator, a transmission, or so forth. The prime mover is disposed on the second side (the left side in FIG. 2) of the power transmission device 100 in the axial direction, whereas the output-side member is disposed on the first side (the right side in FIG. 2) of the power transmission device 100 in the axial direction. The power transmission device 100 is configured to limit a torque transmitted between the prime mover and the output-side member and attenuate fluctuations in torque.

### Drive Plate

The drive plate 2 is configured to receive the torque outputted from the prime mover. Specifically, the drive plate 2 is attached to a crankshaft 102 by a plurality of bolts 101. The drive plate 2 includes a flexible plate 21 and an inertia plate 22.

The flexible plate 21 is configured to receive the torque outputted from the prime mover. Specifically, the flexible plate 21 is attached to the crankshaft 102 by the plural bolts 101. The flexible plate 21 has a disc shape. The flexible plate 21 has flexibility. The flexible plate 21 can be made of a steel plate or so forth; specifically, the flexible plate 21 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The flexible plate 21 has a plate thickness of, for instance, about 2 mm to 4 mm. While the power transmission device 100 is operating, the flexible plate 21 is capable of bending by about 0.3 mm to 0.5 mm in the axial direction, for instance, although the flexible plate 21 is not particularly limited in amount of bending to the above.

The flexible plate 21 includes a protruding portion 211. The protruding portion 211 protrudes to the first side in the axial direction. In other words, the protruding portion 211 protrudes toward the inertia plate 22. The protruding portion 211 is made in the shape of an annulus extending in the circumferential direction.

### Inertia Plate

The inertia plate 22 is disposed on the first side of the flexible plate 21 in the axial direction. The inertia plate 22 is configured to be rotated unitarily with the flexible plate 21. Specifically, the inertia plate 22 is fastened to the flexible plate 21 by the first and third bolts 5a and 5c. The first and third bolts 5a and 5c are disposed away from each other at equal intervals in the circumferential direction.

The inertia plate 22 has an annular shape. The inner peripheral end of the inertia plate 22 is disposed radially inside the protruding portion 211 of the flexible plate 21. The inertia plate 22 has a larger plate thickness than the flexible plate 21. Unlike the flexible plate 21, the inertia plate 22 does not have flexibility. In other words, the inertia plate 22 does not basically bend, while the power transmission device 100 is operating. The inertia plate 22 can be set to have a plate thickness of, for instance, about 5 mm to 7 mm.

The inertia plate 22 can be made of a steel plate or so forth; specifically, the inertia plate 22 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The inertia plate 22 can be formed by sheet metal processing or stamping of a steel plate. Specifically, the inertia plate 22 can be formed by single-stage stamping, progressive stamping, or transfer stamping.

The inertia plate 22 includes a first annular portion 221 and a first cylindrical portion 222. The first annular portion 221 is made in the shape of an annulus extending in the circumferential direction. An outer peripheral part of the first annular portion 221 is in contact with the flexible plate 21 in the axial direction. An inner peripheral part of the first annular portion 221 is disposed away from the flexible plate 21 at an interval in the axial direction. The first annular portion 221 includes a stepped portion 223.

The first cylindrical portion 222 extends from the outer peripheral end of the first annular portion 221 to the first side in the axial direction. In other words, the first cylindrical portion 222 extends from the outer peripheral end of the first annular portion 221 toward the torque fluctuation inhibiting device 110. The first cylindrical portion 222 is formed by bending an outer peripheral part of the inertia plate 22. Because of this, the first cylindrical portion 222 is substantially equal in plate thickness to the first annular portion 221. The first cylindrical portion 222 overlaps with the first and second inertia blocks 4a and 4b as seen in the radial direction.

### Disc Spring

The disc spring 3 is disposed axially between the flexible plate 21 and the inertia plate 22. The disc spring 3 is in contact with the protruding portion 211 of the flexible plate 21 and the inertia plate 22. When described in detail, an outer peripheral end portion 31 of the disc spring 3 is in contact with the inertia plate 22. On the other hand, an inner peripheral end portion 32 of the disc spring 3 is in contact with the protruding portion 211 of the flexible plate 21. It should be noted that, while the power transmission device 100 is not operating, the outer peripheral end portion 31 of the disc spring 3 is not in contact with the flexible plate 21, while the inner peripheral end portion 32 thereof is not in contact with the inertia plate 22.

The disc spring 3 is disposed between the flexible plate 21 and the inertia plate 22, while being compressed therebetween. The outer peripheral surface of the disc spring 3 is in contact with the stepped portion 223 of the inertia plate 22. Accordingly, the disc spring 3 is restricted from moving in the radial direction.

Thus, the disc spring 3 is in contact with the protruding portion 211; hence, when the flexible plate 21 bends in the axial direction, while the power transmission device 100 is operating, the protruding portion 211 slides against the disc spring 3, whereby an occurrence of resonance can be inhibited.

### Inertia Blocks

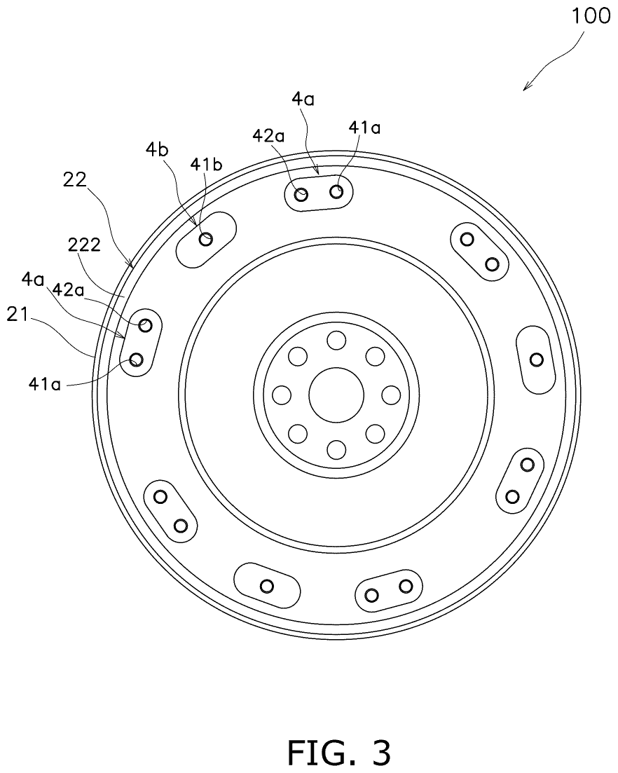

FIG. 3 is a plan view of the power transmission device 100 from which the torque limiter 6 and the damper unit 7 are detached. As shown in FIGS. 1 to 3, the first and second inertia blocks 4a and 4b are disposed axially between the drive plate 2 and the torque fluctuation inhibiting device 110. The first and second inertia blocks 4a and 4b are disposed on the first side of the inertia plate 22 in the axial direction. The first and second inertia blocks 4a and 4b are configured to be rotated unitarily with the drive plate 2.

The first inertia blocks 4a and the second inertia blocks 4b are disposed away from each other at intervals in the circumferential direction. The first inertia blocks 4a and the second inertia blocks 4b are disposed such that the pattern “the first inertia block 4a, the second inertia block 4b, the first inertia block 4a” is repeated in the circumferential direction. The first and second inertia blocks 4a and 4b are disposed in common on the circumference of an imaginary circle. The first and second inertia blocks 4a and 4b are disposed radially inside the first cylindrical portion 222.

Each first inertia block 4a includes a first threaded hole 41a and a second threaded hole 42a. Each first inertia block 4a includes only two threaded holes. Each second inertia block 4b includes a third threaded hole 41b. Each second inertia block 4b includes only one threaded hole. Thus, each second inertia block 4b is different in number of threaded holes provided therein from each first inertia block 4a. When described in detail, each second inertia block 4b is smaller in number of threaded holes than each first inertia block 4a.

Each first inertia block 4a is penetrated by the first and second threaded holes 41a and 42a in the axial direction. Each second inertia block 4b is penetrated by the third threaded hole 41b in the axial direction. The first and second threaded holes 41a and 42a are disposed at an interval in the circumferential direction. The first, second, and third threaded holes 41a, 42a, and 41b are disposed in common on the circumference of an imaginary circle.

The first and third threaded holes 41a and 41b are disposed at equal intervals in the circumferential direction. It should be noted that in the present preferred embodiment, six first threaded holes 41a and three third threaded holes 41b are provided; hence, the first and third threaded holes 41a and 41b are disposed at angular intervals of 40 degrees in the circumferential direction.

One of each pair of first inertia blocks 4a adjacent to each other is opposite in circumferential layout of the first and second threaded holes 41a and 42a to the other. Specifically, when one of each pair of first inertia blocks 4a adjacent to each other is provided with the first threaded hole 41a and the second threaded hole 42a laid out in this order, the other is provided with the second threaded hole 42a and the first threaded hole 41a laid out in this order. In other words, the first and second threaded holes 41a and 42a are aligned such that the layout of the first threaded hole 41a, the second threaded hole 42a, the second threaded hole 42a, and the first threaded hole 41a is repeated in the circumferential direction.

Each second inertia block 4b is disposed between each pair of first inertia blocks 4a in which the second threaded holes 42a are disposed adjacent to each other. It should be noted that each second inertia block 4b is not disposed between each pair of first inertia blocks 4a in which the first threaded holes 41a are disposed adjacent to each other.

The first and second inertia blocks 4a and 4b are fixed to the inertia plate 22 by the first and third bolts 5a and 5c. The first and second inertia blocks 4a and 4b may be fixed to the inertia plate 22 by welding. The first and second inertia blocks 4a and 4b are fixed to an outer peripheral part of the inertia plate 22.

The first and second inertia blocks 4a and 4b overlap with the first cylindrical portion 222 as seen in the radial direction. When described in detail, the first and second inertia blocks 4a and 4b are opposed to the inner peripheral surface of the first cylindrical portion 222. The first and second inertia blocks 4a and 4b overlap with the first annular portion 221 as seen in the axial direction. When described in detail, the first and second inertia blocks 4a and 4b overlap with an outer peripheral part of the first annular portion 221 as seen in the axial direction.

The first and second inertia blocks 4a and 4b are disposed axially between the inertia plate 22 and a first side plate 61 of the torque limiter 6 (to be described). When described in detail, the first and second inertia blocks 4a and 4b are axially sandwiched by the inertia plate 22 and a second side plate 62 of the torque limiter 6 (to be described). When described in more detail, the first and second inertia blocks 4a and 4b are axially sandwiched by the first annular portion 221 and a second outer peripheral portion 622 of the second side plate 62.

Each of the first and second inertia blocks 4a and 4b has a thickness larger than the plate thickness of the first side plate 61. Besides, the thickness of each of the first and second inertia blocks 4a and 4b is larger than the plate thickness of the inertia plate 22. It should be noted that the thickness of each of the first and second inertia blocks 4a and 4b means the axial dimension thereof.

Each first inertia block 4a is identical in shape to each second inertia block 4b except for a difference in number of threaded holes therebetween. In other words, each first inertia block 4a is identical in thickness, circumferential dimension, and radial dimension to each second inertia block 4b. Because of this, it is made possible to manufacture the first and second inertia blocks 4a and 4b with an identical mold, whereby it is made possible to manufacture the first and second inertia blocks 4a and 4b at a low cost.

### Bolts

The drive plate 2 and each inertia block 4a are fastened to each other by each first bolt 5a. When described in detail, each first bolt 5a extends to reach each first inertia block 4a through corresponding through holes of the drive plate 2 from the second side in the axial direction and is further screwed into the first threaded hole 41a of each first inertia block 4a. Accordingly, the flexible plate 21, the inertia plate 22, and each first inertia block 4a are fastened to each other by each first bolt 5a.

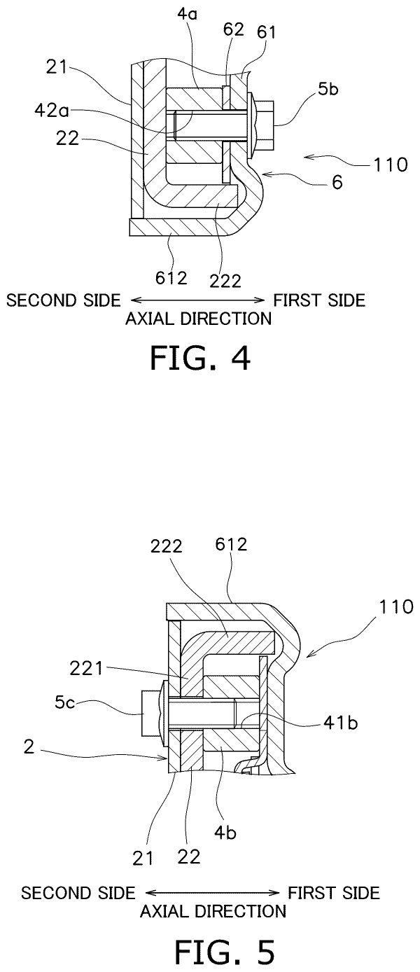

FIG. 4 is a cross-sectional view of the power transmission device 100 taken along line IV-IV in FIG. 1. As shown in FIG. 4, the torque fluctuation inhibiting device 110 and each first inertia block 4a are fastened to each other by each second bolt 5b. When described in detail, each second bolt 5b extends to reach each first inertia block 4a through corresponding through holes of the torque fluctuation inhibiting device 110 from the first side in the axial direction and is further screwed into the second threaded hole 42a provided in each first inertia block 4a. Accordingly, the torque fluctuation inhibiting device 110 and each first inertia block 4a are fastened to each other by each second bolt 5b.

FIG. 5 is a cross-sectional view of the power transmission device 100 taken along line V-V in FIG. 1. As shown in FIG. 5, the drive plate 2 and each second inertia block 4b are fastened to each other by each third bolt 5c. When described in detail, each third bolt 5c extends to reach each second inertia block 4b through corresponding through holes of the drive plate 2 from the second side in the axial direction and is further screwed into the third threaded hole 41b provided in each second inertia block 4b. Accordingly, the flexible plate 21, the inertia plate 22, and each second inertia block 4b are fastened to each other by each third bolt 5c.

### Torque Fluctuation Inhibiting Device

As shown in FIGS. 1 and 2, the torque fluctuation inhibiting device 110 includes the torque limiter 6 and the damper unit 7. The torque fluctuation inhibiting device 110 is configured to inhibit fluctuations in torque.

### Torque Limiter

The torque limiter 6 is disposed to be rotatable about the rotational axis O. The torque limiter 6 is disposed on the first side of the inertia plate 22 in the axial direction. The torque limiter 6 has an annular shape. The torque limiter 6 is attached to the drive plate 2. When described in detail, the torque limiter 6 is attached to the flexible plate 21 through the first and second inertia blocks 4a and 4b and the inertia plate 22.

As shown in FIG. 4, each second bolt 5b is screwed into the second threaded hole 42a provided in each first inertia block 4a, whereby the torque limiter 6 is attached to each first inertia block 4a. It should be noted that each second bolt 5b is not screwed into each second inertia block 4b. In other words, not only the drive plate 2 but also the torque limiter 6 is fixed to each first inertia block 4a; however, only the drive plate 2 is fixed to each second inertia block 4b. The first and third bolts 5a and 5c for fastening the drive plate 2 are larger in total number than the second bolts 5b for fastening the torque limiter 6. The second bolts 5b are disposed away from each other at equal intervals in the circumferential direction.

The torque limiter 6 is configured to limit the torque transmitted between the drive plate 2 and the damper unit 7. In other words, the torque limiter 6 is configured to restrict transmission of the torque in the power transmission device 100 when the torque has a magnitude of a predetermined value or greater. The torque limiter 6 is disposed radially outside the damper unit 7.

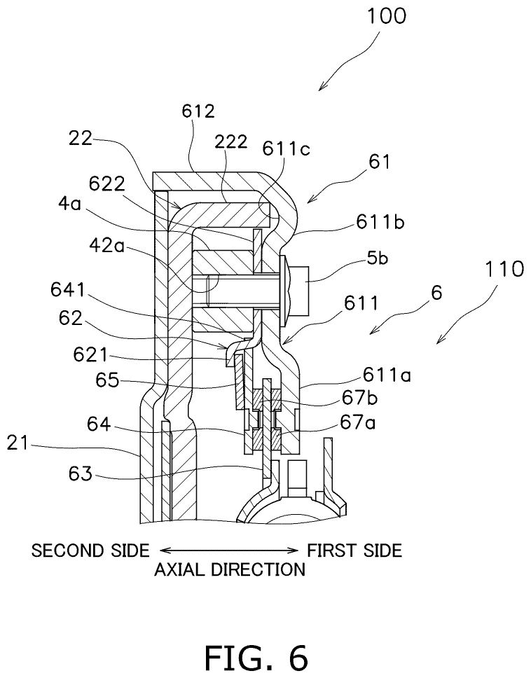

FIG. 6 is an enlarged cross-sectional view of the power transmission device 100. As shown in FIG. 6, the torque limiter 6 includes the first side plate 61, the second side plate 62, a friction plate 63, a pressure plate 64, and an urging member 65.

### First Side Plate

The first side plate 61 is disposed on the first side of the drive plate 2 in the axial direction. The first side plate 61 is attached to the drive plate 2. Specifically, the first side plate 61 is attached to the first inertia blocks 4a fixed to the drive plate 2.

The first side plate 61 is fastened to the first inertia blocks 4a by the second bolts 5b. When described in detail, the second bolts 5b are screwed into the second threaded holes 42a of the first inertia blocks 4a, whereby the first and second side plates 61 and 62 are fixed to the first inertia blocks 4a. The first side plate 61 has an annular shape.

The first side plate 61 includes a second annular portion 611 and a second cylindrical portion 612. The second annular portion 611 and the second cylindrical portion 612 are integrated as a single member.

The second annular portion 611 is made in the shape of an annulus extending in the circumferential direction. The second annular portion 611 includes a first inner peripheral portion 611a and a first outer peripheral portion 611b. The first inner peripheral portion 611a is in contact with the friction plate 63. The first inner peripheral portion 611a is disposed on the first side of the first outer peripheral portion 611b in the axial direction. The first outer peripheral portion 611b is disposed radially outside the first inner peripheral portion 611a. The first outer peripheral portion 611b overlaps with the first and second inertia blocks 4a and 4b as seen in the axial direction.

The second annular portion 611 includes a recess 611c made in the shape of an annulus extending in the circumferential direction. The recess 611c recesses in a direction separating from the inertia plate 22. In other words, the recess 611c recesses to the first side in the axial direction. The recess 611c is opposed to the first cylindrical portion 222 as seen in the axial direction. The distal end of the first cylindrical portion 222 is disposed in the recess 611c.

The second cylindrical portion 612 extends from the outer peripheral end of the second annular portion 611 in the axial direction. When described in detail, the second cylindrical portion 612 extends from the outer peripheral end of the second annular portion 611 to the second side in the axial direction. In other words, the second cylindrical portion 612 extends from the outer peripheral end of the second annular portion 611 toward the drive plate 2 in the axial direction.

The second cylindrical portion 612 is disposed radially outside the first cylindrical portion 222. The second cylindrical portion 612 overlaps with the first cylindrical portion 222 as seen in the radial direction. Besides, the second cylindrical portion 612 overlaps with the first and second inertia blocks 4a and 4b as seen in the radial direction. The second cylindrical portion 612 is larger in length than the first cylindrical portion 222. The second cylindrical portion 612 covers the entirety of the outer peripheral surface of the first cylindrical portion 222. The second cylindrical portion 612 serves as the outer peripheral surface of the power transmission device 100. The second cylindrical portion 612 extends to the position of the flexible plate 21 in the axial direction. The outer peripheral surface of the flexible plate 21 is in contact with the inner peripheral surface of the second cylindrical portion 612.

The second cylindrical portion 612 is formed by bending an outer peripheral part of the first side plate 61 to the second side in the axial direction. Because of this, the second cylindrical portion 612 is substantially equal in plate thickness to the second annular portion 611. It should be noted that the first side plate 61 can be set to have a plate thickness of, for instance, about 2.0 mm to 8.0 mm.

The first side plate 61 can be made of a steel plate or so forth; specifically, the first side plate 61 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The first side plate 61 can be formed by sheet metal processing or stamping of a steel plate. Specifically, the first side plate 61 can be formed by single-stage stamping, progressive stamping, or transfer stamping.

### Second Side Plate

The second side plate 62 is disposed on the second side of the first side plate 61 in the axial direction. In other words, the second side plate 62 is disposed axially between the inertia plate 22 and the first side plate 61. When described in detail, the second side plate 62 is disposed in a space defined by the first annular portion 221, the first cylindrical portion 222, and the second annular portion 611.

The friction plate 63, the pressure plate 64, and the urging member 65 are disposed axially between the first and second side plates 61 and 62. The second side plate 62 has a smaller plate thickness than the first side plate 61.

The second side plate 62 is configured to be rotated unitarily with the first side plate 61. The second side plate 62 is fastened to the first side plate 61 by a plurality of fastening members 66 (see FIG. 2). The fastening members 66 are disposed at intervals in the circumferential direction. The fastening members 66 are, for instance, rivets or bolts. The first and second side plates 61 and 62 are fixed to the first inertia blocks 4a by the second bolts 5b, while being fastened to each other by the fastening members 66 as herein described.

The second side plate 62 includes a second inner peripheral portion 621 and the second outer peripheral portion 622. The second inner peripheral portion 621 supports the urging member 65. The second inner peripheral portion 621 is disposed on the second side of the second outer peripheral portion 622 in the axial direction. The second inner peripheral portion 621 is disposed away from the first inner peripheral portion 611a at an interval in the axial direction. The friction plate 63, the pressure plate 64, and the urging member 65 are disposed axially between the first and second inner peripheral portions 611a and 621.

The second outer peripheral portion 622 is disposed radially outside the second inner peripheral portion 621. The second outer peripheral portion 622 is in contact with the first outer peripheral portion 611b in the axial direction. The second outer peripheral portion 622 is held by the first outer peripheral portion 611b and the first and second inertia blocks 4a and 4b, while being axially interposed therebetween. It should be noted that another member may be interposed between the first and second inertia blocks 4a and 4b and the second outer peripheral portion 622.

The outer peripheral surface of the second side plate 62 is opposed to the inner peripheral surface of the first cylindrical portion 222. The outer peripheral surface of the second side plate 62 may be in contact with the inner peripheral surface of the first cylindrical portion 222, or alternatively, may be disposed away therefrom at an interval.

### Friction Plate

The friction plate 63 is a plate made in the shape of an annulus extending in the circumferential direction. The friction plate 63 is disposed to be rotatable about the rotational axis O. The friction plate 63 is disposed to be rotatable relative to the first side plate 61.

The friction plate 63 is in contact with the first side plate 61 in the axial direction. When described in detail, the friction plate 63 is in contact with the first inner peripheral portion 611a of the second annular portion 611 in the axial direction. When described in more detail, the friction plate 63 is in contact with a first friction material 67a attached to the first side plate 61. The first friction material 67a is rotated unitarily with the first side plate 61. It should be noted that the first friction material 67a may be attached to the friction plate 63. The friction plate 63 is configured to be engaged by friction with the first side plate 61.

The friction plate 63 is attached to a first rotary member 71 of the damper unit 7 (to be described). When described in detail, the friction plate 63 is attached to a second plate 71b. For example, the friction plate 63 is attached to the second plate 71b by a plurality of fastening members 105 (see FIG. 2). The friction plate 63 is rotated unitarily with the first rotary member 71. It should be noted that the friction plate 63 is provided as a discrete member separated from the second plate 71b; alternatively, the friction plate 63 may be integrated with the second plate 71b as a single member.

### Pressure Plate

The pressure plate 64 has an annular shape. The pressure plate 64 is disposed axially between the urging member 65 and the friction plate 63. The pressure plate 64 holds the friction plate 63 in cooperation with the first side plate 61, with the friction plate 63 interposed therebetween.

The pressure plate 64 is configured to be rotated unitarily with the first side plate 61. It should be noted that the pressure plate 64 is axially movable with respect to the first side plate 61. Specifically, the pressure plate 64 includes a plurality of protruding portions 641 protruding radially outward. The protruding portions 641 are engaged with engaging holes provided in the second side plate 62, respectively, whereby the pressure plate 64 is rotated unitarily with the second side plate 62, while being axially movable with respect thereto. The second side plate 62 is rotated unitarily with the first side plate 61 but is axially immovable with respect thereto; hence, the pressure plate 64 is rotated unitarily with the first side plate 61, while being axially movable with respect thereto.

The pressure plate 64 is provided with a second friction material 67b attached thereto. When rotated relative to the pressure plate 64, the friction plate 63 slides against the second friction material 67b. It should be noted that the second friction material 67b may be attached to the friction plate 63.

### Urging Member

The urging member 65 is disposed axially between the second side plate 62 and the pressure plate 64. The urging member 65 urges the pressure plate 64 to the first side in the axial direction. In other words, the urging member 65 urges the pressure plate 64 toward the first side plate 61. Accordingly, the friction plate 63 is sandwiched by the pressure plate 64 and the first side plate 61. The urging member 65 is made in the shape of an annulus extending in the circumferential direction. The urging member 65 is, for instance, a disc spring. The urging member 65 is in contact at an outer peripheral end portion thereof with the second inner peripheral portion 621, while being in contact at an inner peripheral end portion thereof with the pressure plate 64.

### Damper Unit

As shown in FIG. 2, the damper unit 7 is attached to the drive plate 2. When described in detail, the damper unit 7 is attached to the torque limiter 6. In other words, the damper unit 7 is attached to the drive plate 2 through the torque limiter 6 and the first and second inertia blocks 4a and 4b. The damper unit 7 is configured to attenuate fluctuations in rotation. The damper unit 7 includes the first rotary member 71, a second rotary member 72, and a plurality of elastic members 73.

### First Rotary Member

The first rotary member 71 is configured to receive the torque outputted from the drive plate 2. When described in detail, the first rotary member 71 receives the torque outputted from the drive plate 2 through the torque limiter 6. The first rotary member 71 is rotated unitarily with the friction plate 63 of the torque limiter 6. The first rotary member 71 includes a first plate 71a and the second plate 71b. Each of the first and second plates 71a and 71b is an annular member including a center hole. The first and second plates 71a and 71b are rotated unitarily with each other. Besides, the first and second plates 71a and 71b are axially immovable relative to each other. The first and second plates 71a and 71b are fastened to each other by a plurality of fastening members 106.

The first and second plates 71a and 71b are disposed away from each other at an interval in the axial direction. The second plate 71b is disposed on the second side of the first plate 71a in the axial direction.

The first plate 71a includes a plurality of window portions 711a, while the second plate 71b includes a plurality of window portions 711b. It should be noted that in the present preferred embodiment, the first plate 71a includes four window portions 711a, while the second plate 71b includes four window portions 711b; however, the window portions 711a, 711b are not limited in number to this.

Not only the window portions 711a but also the window portions 711b are disposed away from each other at intervals in the circumferential direction. Not only the window portions 711a but also the window portions 711b are configured to accommodate the elastic members 73, respectively.

The first rotary member 71 overlaps at an outer peripheral part thereof with friction surfaces, at which the friction plate 63 and the first side plate 61 are in contact with each other, as seen in the axial direction. The outer peripheral part of the first rotary member 71 is disposed on the first side of the torque limiter 6 in the axial direction.

### Second Rotary Member

The second rotary member 72 is configured to transmit the torque, outputted thereto from the first rotary member 71, to the output-side member. The second rotary member 72 is disposed axially between the first and second plates 71a and 71b. The second rotary member 72 is disposed to be rotatable relative to the first and second plates 71a and 71b.

The second rotary member 72 includes a hub 721 and a flange plate 722. The hub 721 and the flange plate 722 are separated as different members; alternatively, the hub 721 and the flange plate 722 may be integrated as a single member.

The hub 721 has a tubular shape and extends in the axial direction. The hub 721 is disposed in the center hole of the first plate 71a and that of the second plate 71b. The hub 721 is provided with a spline hole, extending in the axial direction, in an inner peripheral part thereof. The spline hole enables an input shaft of the output-side member to be spline-coupled thereto.

The flange plate 722 radially extends from the outer peripheral surface of the hub 721. The flange plate 722 has an annular shape. The flange plate 722 is disposed to be rotatable relative to the first and second plates 71a and 71b. The flange plate 722 is disposed axially between the first and second plates 71a and 71b.

The flange plate 722 includes a plurality of accommodation holes 723. It should be noted that in the present preferred embodiment, the flange plate 722 includes four accommodation holes 723; however, the accommodation holes 723 are not limited in number to this. The accommodation holes 723 are disposed away from each other at intervals in the circumferential direction. The accommodation holes 723 are configured to accommodate the elastic members 73, respectively. The accommodation holes 723 are set in place to overlap with not only the window portions 711a but also the window portions 711b, respectively, as seen in the axial direction.

### Elastic Members

The elastic members 73 are configured to elastically couple the first and second rotary members 71 and 72 in a rotational direction. The elastic members 73 are, for instance, coil springs.

The elastic members 73 are accommodated in the accommodation holes 723 of the second rotary member 72, respectively. Besides, the elastic members 73 are accommodated in not only the window portions 711a of the first plate 71a but also the window portions 711b of the second plate 71b, respectively. The elastic members 73 are disposed radially inside the torque limiter 6.

### Modifications

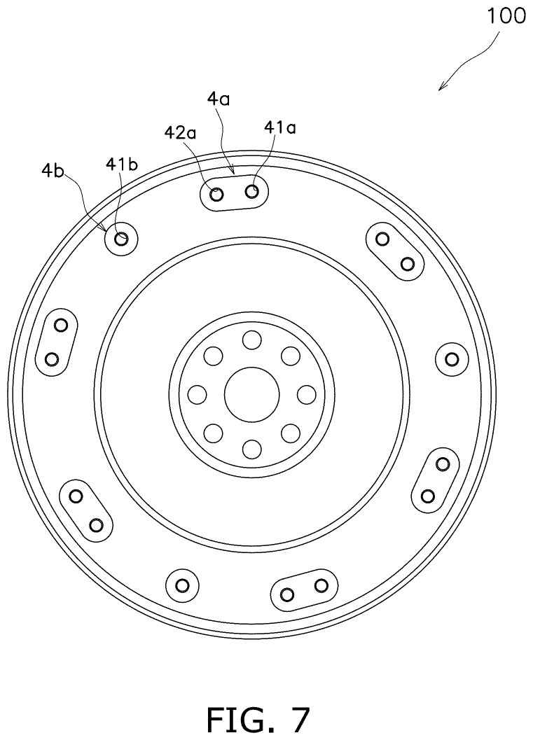

One preferred embodiment of the present invention has been explained above. However, the present invention is not limited to the above, and it will be apparent to one of ordinary skill in the art from this disclosure that a variety of changes can be made without departing from the gist of the present invention. It should be noted that basically speaking, respective modifications to be described are applicable separately or in combination in an embodiment.
(a) In the preferred embodiment described above, the first and second threaded holes 41a and 42a, provided in each first inertia block 4a, are disposed at an interval in the circumferential direction; however, each first inertia block 4a is not limited in configuration to this. For example, the first and second threaded holes 41a and 42a may be provided at an interval in the radial direction.
(b) Each first inertia block 4a may be provided with not only the first and second threaded holes 41a and 42a but also at least one additional threaded hole; likewise, each second inertia block 4b may be provided with not only the third threaded hole 41b but also at least one additional threaded hole. In this case, each inertia block 4a is larger in number of threaded holes than each second inertia block 4b.
(c) As shown in FIG. 7, each first inertia block 4a and each second inertia block 4b may be different in shape from each other.

### LIST OF REFERENCE NUMERALS

2: Drive plate, 21: Flexible plate, 22: Inertia plate, 222: First cylindrical portion, 4a: First inertia block, 41a: First threaded hole, 42a: Second threaded hole, 4b: Second inertia block, 41b: Third threaded hole, 5a: First bolt, 5b: Second bolt, 5c: Third bolt, 6: Torque limiter, 61: First side plate, 612: Second cylindrical portion, 63: Friction plate, 64: Pressure plate, 65: Urging member, 7: Damper unit, 100: Power transmission device, 110: Torque fluctuation inhibiting device.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “plurality,” as used herein, can encompass the configuration in which each element of a plurality of elements has a different shape or structure from each other in addition to the configuration in which the plurality of elements have the same shapes or structures as each other.

The terms “a” (or “an”), “one or more” and “at least one” can be used interchangeably herein. The phrase “at least one of” as used in this disclosure means “one or more” of a desired choice.

Terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Modifications and variations of the present invention will be apparent to one of ordinary skill in the art in light of this disclosure. It is therefore to be understood that within the scope of the appended claims, the invention may be practiced otherwise than as specifically described herein.

1. A power transmission device comprising:
a drive plate;
a torque fluctuation inhibiting device configured to inhibit fluctuations in torque;
a first inertia block including a first threaded hole and a second threaded hole, the first inertia block disposed between the drive plate and the torque fluctuation inhibiting device in an axial direction;
a second inertia block including a third threaded hole, the second inertia block disposed between the drive plate and the torque fluctuation inhibiting device in the axial direction, the second inertia block disposed away from the first inertia block at an interval in a circumferential direction;
a first bolt screwed into the first threaded hole of the first inertia block, the first bolt fastening the drive plate and the inertia block therethrough to each other;
a second bolt screwed into the second threaded hole of the first inertia block, the second bolt fastening the torque fluctuation inhibiting device and the first inertia block therethrough to each other; and
a third bolt screwed into the third threaded hole of the second inertia block, the third bolt fastening the drive plate and the second inertia block therethrough to each other.

2. The power transmission device according to claim 1, wherein the first inertia block is identical in shape to the second inertia block except for difference in number between the first and second threaded holes and the third threaded hole.

3. The power transmission device according to claim 1, wherein
the drive plate includes a first cylindrical portion extending in the axial direction, and
the first and second inertia blocks are disposed radially inside the first cylindrical portion.

4. The power transmission device according to claim 3, wherein
the drive plate includes a flexible plate and an inertia plate, the inertia plate configured to be rotated unitarily with the flexible plate, the inertia plate having an annular shape, the inertia plate having a larger plate thickness than the flexible plate, and
the inertia plate includes the first cylindrical portion.

5. The power transmission device according to claim 3, wherein
the torque fluctuation inhibiting device includes a second cylindrical portion extending in the axial direction, and
the second cylindrical portion is disposed radially outside the first cylindrical portion.

6. The power transmission device according to claim 1, wherein
the torque fluctuation inhibiting device includes a torque limiter attached to the drive plate,
the torque limiter includes
a first side plate,
a friction plate disposed to be rotatable relative to the first side plate,
a pressure plate holding the friction plate in cooperation with the first side plate, with the friction plate interposed therebetween, and
an urging member urging the pressure plate toward the first side plate in the axial direction, and
the second bolt fastens the first side plate and the first inertia block therethrough to each other.

7. The power transmission device according to claim 2, wherein
the drive plate includes a first cylindrical portion extending in the axial direction, and
the first and second inertia blocks are disposed radially inside the first cylindrical portion.

8. The power transmission device according to claim 4, wherein
the torque fluctuation inhibiting device includes a second cylindrical portion extending in the axial direction, and
the second cylindrical portion is disposed radially outside the first cylindrical portion.

9. The power transmission device according to claim 2, wherein
the torque fluctuation inhibiting device includes a torque limiter attached to the drive plate,
the torque limiter includes
a first side plate,
a friction plate disposed to be rotatable relative to the first side plate,
a pressure plate holding the friction plate in cooperation with the first side plate, with the friction plate interposed therebetween, and
an urging member urging the pressure plate toward the first side plate in the axial direction, and
the second bolt fastens the first side plate and the first inertia block therethrough to each other.

10. The power transmission device according to claim 1, wherein
the first inertia block is a different shape than the second inertia block.
